(19) United States
(12) Patent Application Publication
(10) Pub. No.: US 2015/0053077 A1
(43) Pub. Date: Feb. 26, 2015

(54) GREY CAST IRON HAVING EXCELLENT DURABILITY

(71) Applicants: Kia Motors Corporation, Seoul (KR); Hyundai Motor Company, Seoul (KR)

(72) Inventor: Duk-Hyun Nam, Osan (KR)

(73) Assignees: Kia Motors Corporation, Seoul (KR); Hyundai Motor Company, Seoul (KR)

(21) Appl. No.: 14/142,877

(22) Filed: Dec. 29, 2013

(30) Foreign Application Priority Data
Aug. 21, 2013 (KR) 10-2013-0099101

(51) Int. Cl. C22C 37/10; F02F 1/00; B22D 13/02; C22C 37/00; C22C 37/06

(52) U.S. Cl. CPC C22C 37/10; C22C 37/00; C22C 37/06; B22D 13/02; F02F 1/004; F02F 2200/06
USPC 92/169.1; 420/26; 420/15; 164/118

(57) ABSTRACT

Disclosed is grey cast iron having an excellent durability and comprising carbon (C) in an amount of about 2.6 to 3.2 wt %, copper (Cu) in an amount of about 0.7 to 0.9 wt %, phosphorus (P) in an amount of about 0.4 to 0.7 wt %, molybdenum (Mo) in an amount of about 0.2 to 0.4 wt %, tin (Sn) in an amount of about 0.02 to 0.08 wt %, and a balance of iron (Fe) and trace amounts of unavoidable impurities, and a method for production thereof. The present invention improves tensile strength, fatigue strength, and the like and further reduces friction coefficient of the grey cast iron as compared with a conventional material. The grey cast iron has an excellent durability and provides a cost reduction of about 10% or more as compared with a conventional material.

### CROSS-REFERENCE TO RELATED APPLICATIONS

This application claims priority under 35 U.S.C. §119 to Korean Patent Application No. 10-2013-0099101, filed on Aug. 21, 2013, in the Korean Intellectual Property Office, the disclosure of which is incorporated herein by reference in its entirety.

### BACKGROUND OF INVENTION

1. Field of the Invention

The present invention relates to grey cast iron suitable for use in parts requiring an excellent durability, such as cylinder liners of automobiles, and methods for production. More particularly, the grey cast iron having an excellent durability comprises micro-structures, such as pearlite, flake graphite, and a precipitate phase.

2. Description of the Related Art

Cast iron is an alloy of iron, and contains carbon (C) in an amount of about 1.7%45%, if the cast iron contains more carbon than this range, it becomes rigid and brittle, and, thus, it is not suitable for a rolling process and a forging process. However, as compared with steel, cast iron has a lower melting point and can be easily melted, and, thus, it is easy to use as a cast.

The cast iron has a high strength. Further, as compared with steel, cast iron generates less rust and is cheap. Therefore, the cast iron has been widely used in various applications, from machine parts to cooking utensils.

In the cast iron, carbon (C) can be present in two forms, a cementite (Fe₃C) form and a graphite form containing carbon alone. Depending on the type of carbon in the cast iron, properties thereof differ. Whether the carbon (C) is present in the form of cementite or graphite is determined by the amounts of the carbon (C) and silicon (Si) contained in the cast iron, and the cooling rate utilized during a casting process.

To be more specific, if the carbon (C) or the silicon (Si) is contained in a small amount and a casting processing is carried out with rapid cooling, the carbon is present in the form of cementite. Cementite is a rigid compound, and, thus, a cast iron containing cementite in a large amount becomes rigid and has an, excellent abrasion resistance, but can be easily broken due to it's a high brittleness. Such cast iron has a compact texture and has a shiny white finish in a cross-sectional view. As such, it is often referred to as white cast iron.

On the other hand, if a cooling rate is low during the casting process and the carbon (C) and the silicon (Si) are sufficient, the carbon (C) can be isolated and can be easily present in the form of graphite. Such cast iron is softer than the white cast iron, but is not brittle as compared with the white cast iron. This form of case iron has a grey appearance in a cross-sectional view due to black graphite mixed therein, and, thus, it is often referred to as grey cast iron.

The grey cast iron is relatively cheap and has excellent characteristics, such as a vibration damping capacity, machinability, heat resistance, and heat conductivity. Therefore, grey cast iron having various element ratios has been developed and widely used in forming a block, a cylinder head, etc. of an internal combustion engine.

In recent years, an increasing trend has been to provide high-torque engines in automobile. However, with grey cast iron as conventionally used, it is difficult to satisfy a requisite durability, such as tensile strength, fatigue strength, and friction characteristic, required to operate such high-torque engines of automobiles. More specifically, a main bearing positioned at a cylinder block or a fire face positioned at a cylinder head requires a tensile strength of at least 300 MPa. However, the conventional grey cast iron has a tensile strength of up to about 250 MPa. Thus, the conventional grey cast iron cannot be used successfully.

Therefore, in order to satisfy durability and friction characteristics required for high-torque engines, bainite-based cast iron, having a tensile strength of about 400 MPa through the addition of nickel (Ni) and molybdenum (Mo), has been developed and applied. However, such a cast iron has limited application due to its high price.

Thus, what is needed is a grey cast iron having an excellent durability, which has tensile strength, fatigue strength and friction characteristics sufficient for application to high-torque engines, and is also economical due to its low price.

### SUMMARY OF THE INVENTION

The present invention has been made in an effort to provide grey cast iron having an excellent durability. In particular, the grey cast iron of the present invention is improved in tensile strength and fatigue strength, and has a reduced friction coefficient since, particularly due to its content of carbon (C), cooper (Cu), phosphorus (P), molybdenum (Mo), tin (Sn), and iron (Fe).

According to one aspect, the present invention provides grey cast iron comprising carbon (C) in an amount of about 2.6 to 3.2 wt %, copper (Cu) in an amount of about 0.7 to 0.9 wt %, phosphorus (P) in an amount of about 0.4 to 0.7 wt %, molybdenum (Mo) in an amount of about 0.2 to 0.4 wt %, tin (Sn) in an amount of about 0.02 to 0.08 wt %, and a balance of iron (Fe) and other unavoidable impurities, wherein the wt % is based on the total weight of the grey cast iron composition.

According to various embodiments, the grey cast iron further comprises silicon (Si) in an amount of about 1.8 to 2.2 wt %, manganese (Mn) in an amount of about 0.6 to 1.0 wt %, chromium (Cr) in an amount of less than about 0.4 wt % (and greater than 0 wt %), and sulfur (S) in an amount of less than about 0.1 wt % (and greater than 0 wt %), wherein the wt % is based on the total weight of the grey cast iron composition.

According to a preferred embodiment, the tin (Sn), the chromium (Cr), and the copper (Cu) satisfy a relationship of about 1.1 wt %≦about (5×wt % of Sn+wt % of Cr+wt % of Cu)≦about 1.5 wt %.

According to various embodiments, the grey cast iron has a tensile strength of about 270 to 400 MPa, fatigue strength of about 120 to 190 MPa, and a friction coefficient of about 0.03 to 0.05.

According to another aspect, the present invention provides a method for manufacturing a cylinder liner comprising: putting a melted grey cast iron composition into a mold, the composition comprising carbon (C) in an amount of about 2.6 to 3.2 wt %, copper (Cu) in an amount of about 0.7 to 0.9 wt %, phosphorus (P) in an amount of about 0.4 to 0.7 wt %, molybdenum (Mo) in an amount of about 0.2 to 0.4 wt %, tin (Sn) in an amount of about 0.02 to 0.08 wt %, and a balance of iron (Fe), with trace amounts of other unavoidable impurities; rotating the mold to generate a centrifugal force that presses the grey cast iron melted composition against an inner wall of the mold to thereby form a cylindrical cast; and cooling the cylindrical cast and removing the cylindrical cast from the mold. The above wt % are based on the total weight of the melted grey cast iron composition.

According to preferred embodiments, the melted composition further comprises silicon (Si) in an amount of about 1.8 to 2.2 wt %, manganese (Mn) in an amount of about 0.6 to 1.0 wt %, chromium (Cr) in an amount of less than about 0.4 wt % (and greater than 0 wt %), and sulfur (S) in an amount of less than about 0.1 wt % (and greater than 0 wt %), based on the total weight of the melted grey cast iron composition.

According to a preferred embodiment, the tin (Sn), the chromium (Cr), and the copper (Cu) of the melted composition satisfies a relationship of about 1.1 wt %≦about (5×wt % of Sn wt % of Cr+wt % of Cu)≦about 1.5 wt %.

The present invention configured as described above provides a grey cast iron with uniform micro-structures such as pearlite, flake graphite, and a precipitate phase. As such, tensile strength and fatigue strength can be improved and a friction coefficient can be reduced as compared with a conventional grey cast iron.

Further, the present invention can reduce costs by about 10% or more if substituted for an expensive Ni—Mo-based material conventionally used. More specifically, if the grey cast iron of the present invention is applied to a heavy duty diesel engine instead of high Ni—Mo-based cast iron material, it is possible to reduce the cost of engines. Other features and aspects of the present invention will be apparent from the following detailed description, drawings and claims.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an optical microscopic image taken at a 500 times magnification of a micro-structure of Example 1, which is in accordance with an embodiment of the present invention.

FIG. 2 is an optical microscopic image taken at a 500 times magnification of a micro-structure of Example 2, which is in accordance with an embodiment of the present invention.

FIG. 3 is an optical microscopic image taken at a 500 times magnification of a micro-structure of Comparative Example 1, which is a conventional material.

FIG. 4 is an optical microscopic image taken at a 500 times magnification of a micro-structure of Comparative Example 2, which is a conventional material.

FIG. 5 is an optical microscopic image taken at a 500 times magnification of a micro-structure of Comparative Example 3, which is a conventional material.

FIG. 6 is an optical microscopic image taken at a 500 times magnification of a micro-structure of Comparative Example 4, which is a conventional material.

FIG. 7 is an optical microscopic image taken at a 500 times magnification of a micro-structure of Comparative Example 5, which is a conventional material.

It should be understood that the appended drawings are not necessarily to scale, presenting a somewhat simplified representation of various preferred features illustrative of the basic principles of the invention.

In the figures, reference numbers refer to the same or equivalent pails of the present invention throughout the several figures of the drawing.

### DETAILED DESCRIPTION OF THE EMBODIMENTS

The terms and words used in the specification and claims are not supposed to be construed in a conventional manner or on a dictionary basis, and the inventors are supposed to use the terms and words well matching with the technical concepts based on the principles that the concepts of the terms and words can be properly construed in order to describe the present invention in the best way.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, the present invention will be explained in detail with reference to Tables and the accompanying drawings.

The present invention relates to grey cast iron having excellent durability.

According to the present invention, the grey cast iron having an excellent durability comprises a combination of carbon (C), copper (Cu), phosphorous (P), molybdenum (Mo), tin (Sn) and iron (Fe). Trace amounts of unavoidable impurities may further be included. More particularly, the grey cast iron may comprise carbon (C) in an amount of about 2.6 to 3.2 wt %, copper (Cu) in an amount of about 0.7 to 0.9 wt %, phosphorus (P) in an amount of about 0.4 to 0.7 wt %, molybdenum (Mo) in an amount of about 0.2 to 0.4 wt %, tin (Sn) in an amount of about 0.02 to 0.08 wt %, and a balance of iron (Fe), as well as trace amounts of unavoidable impurities. According to some embodiments, the composition furthers comprise silicon (Si) in an amount of about 1.8 to 2.2 wt %, manganese (Mn) in an amount of about 0.6 to 1.0 wt %, chromium (Cr) in an amount of less than about 0.4 wt % (and greater than 0 wt %), and sulfur (S) in an amount of less than about 0.1 wt % (and greater than 0 wt %).

According to a preferred embodiment, the tin (Sn), the chromium (Cr), and the copper (Cu) satisfy a relationship formula about 1.1 wt %≦about (5×wt % of Sn+wt % of Cr+wt % of Cu)≦about 1.5 wt %.

According to embodiments of the present invention, the grey cast iron having the above composition has uniform micro-structures such as pearlite, flake graphite, and a precipitate phase.

Hereinafter, the composition and the contents of the present invention will be explained in further detail.

1. Carbon (C)

The carbon (C) forms flake graphite when molten grey cast iron is solidified, and precipitates carbide in the grey cast iron, thereby improving hardness, abrasion resistance, seizure resistance, etc. of the grey cast iron.

Preferably, the carbon (C) is contained in the grey cast iron composition an amount of about 2.6 to 3.2 wt %, based on the total weight of the grey cast iron composition. If the carbon (C) is contained in an amount of less than 2.6 wt %, flake graphite is not sufficiently formed and the fluidity of a grey cast iron melted composition is sharply decreased, which may cause a casting defect and decreases an abrasion resistance against kinetic friction, seizure resistance, and lubricating property. On the other hand, if the carbon (C) is contained in an amount of more than 3.2 wt %, flake graphite becomes coarse and a network structure is increased, which may cause a decrease in strength and fatigue life of the grey cast iron.

Further, as the carbon equivalent (Ceq=C+1/3(Si)), which is calculated with the carbon (C) and the silicon (Si) content, reaches 4.3 wt % as the eutectic point, the melting point of the grey cast iron is decreased. Therefore, the fluidity of molten metal can be improved and it becomes easier to perform a cast process under such conditions. However, under such conditions, an amount of graphite crystallized may increase at the same time. Thus, a hardness and a strength of the grey cast iron can be decreased. As such, the content of the carbon and silicon are appropriately provided so as to obtain a desirable carbon equivalent.

2. Copper (Cu)

The copper (Cu) promotes and stabilizes formation of pearlite and strengthens solid-solution and precipitation, thereby improving a strength of the grey cast iron. According to preferred embodiments, the copper (Cu) is contained in the composition an amount of 0.7 to 0.9 wt %, based on total weight of the grey cast iron composition. If the copper (Cu) is contained in an amount of less than 0.7 wt %, pearlite is not sufficiently formed, which may cause a decrease in a strength of the grey cast iron. On the other hand, if the copper (Cu) is contained in an amount of more than 0.9 wt %, pearlite is formed excessively, which may cause a decrease in processability of the grey cast iron.

3. Phosphorous (P)

The phosphorous (P) forms a high-hardness steadite phase having a composition of iron phosphide (Fe₃P) on a matrix, thereby improving an abrasion resistance of the grey cast iron.

Preferably, the phosphorus (P) is contained in the grey cast iron composition in an amount of about 0.4 to 0.7 wt %, based on total weight of the grey cast iron composition. If the phosphorous (P) is contained in an amount of less than 0.4 wt %, it is difficult to sufficiently form a steadite phase, which may cause a lack of an abrasion resistance of the grey cast iron. On the other hand, if the phosphorus (P) is contained in an amount of more than 0.7 wt %, a steadite phase can be coarsened, which may cause a decrease in processability of the grey cast iron.

4. Molybdenum (Mo)

The molybdenum (Mo) forms flake graphite and micro carbide, which are stable at a high temperature, and refines pearlite, thereby improving properties of the grey cast iron. Preferably, the molybdenum (Mo) is contained in the grey cast iron composition in an amount of about 0.2 to 0.4 wt %, based on total weight of the grey cast iron composition. If the molybdenum (Mo) is contained in an amount of less than 0.2 wt %, it is difficult to form micro carbide. On the other hand, if the molybdenum (Mo) is contained in an amount of more than 0.4 wt %, coarsened carbide may be formed, which may cause abrasion on parts.

5. Tin (Sn)

The tin (Sn) promotes and stabilizes formation of pearlite and strengthens solid-solution and precipitation, thereby improving strength of the grey cast iron. Preferably, the tin (Sn) is contained in the grey cast iron composition in an amount of about 0.02 to 0.08 wt %, based on total weight of the grey cast iron composition. If the tin (Sn) is contained in an amount of less than 0.02 wt %, it may be difficult to provide a sufficient strength to the grey cast iron. Meanwhile, if the tin (Sn) is contained in an amount of more than 0.08 wt %, pearlite is formed excessively, which may cause a decrease in processability of the grey cast iron.

6. Silicon (Si)

The silicon (Si) is one of the main elements for determining the carbon equivalent together with the carbon. As silicon content is increased in the carbon equivalent, graphitization where cementite (iron carbide (Fe₃C)) in the grey cast iron is decomposed to free carbon and iron occurs, which promotes formation of flake graphite. AS a result, a corrosion resistance can be improved and brittleness can be reduced.

Preferably, the silicon (Si) is contained in the grey cast iron composition in an amount of 1.8 to 2.2 wt %, based on total weight of the grey cast iron composition. If the silicon (Si) is contained in an amount of less than 1.8 wt %, a cementite structure, which is rigid but highly brittle, is grown, which may cause an increase in a brittleness of the grey cast iron. On the other hand, if the silicon (Si) is contained in an amount of more than 2.2 wt %, flake graphite is coarsened, which may cause a decrease in strength of the grey cast iron.

7. Manganese (Mn)

The manganese (Mn) forms manganese sulfide (MnS) in a lubrication phase and acts as a lubricating agent in combination with sulfur (S). Further, the manganese (Mn) acts as a carbide stabilizing element such that the carbide is finely distributed in the form of carbide within the matrix of the grey cast iron, thereby increasing strength of the matrix.

Preferably, the manganese Mn) is contained in the grey cast iron composition in an amount of about 0.6 to 1.0 wt %, based on total weight of the grey cast iron composition. If the manganese (Mn) is contained in an amount of less than 0.6 wt %, strength of the matrix may be sharply decreased. On the other hand, if the manganese (Mn) is contained in an amount of more than 1.0 wt %, crystallization of graphite is suppressed, which may cause a delay in graphitization, and carbide becomes coarsened, which may cause deterioration of fire resistance and other properties of the grey cast iron.

8. Chromium (Cr)

Like the copper (Cu) component, chromium (Cr) promotes and stabilizes formation of pearlite and strengthens solid-solution and precipitation, thereby improving strength of the grey cast iron. Preferably, the chromium (Cr) is contained in the grey cast iron composition in an amount of less than about 0.4 wt % (and greater than 0 wt %), based on total weight of the grey cast iron composition. If the chromium (Cr) is contained in an amount of 0.4 wt % or more, coarsened carbide may be formed, which may cause abrasion on parts.

9. Sulfur (S)

The sulfur (S) forms manganese sulfide (MnS) in combination with the manganese (Mn) and acts in a lubrication phase when the grey cast iron is processed. Preferably, the sulfur (S) is contained in the grey cast iron composition in an amount of less than about 0.1 wt % (and greater than 0 wt %), based on total weight of the grey cast iron composition. Herein, if the sulfur (S) is contained in an amount of more than 0.1 wt %, coarsened carbide may be formed, which may cause deterioration of properties the grey cast iron.

10. Contents of Tin (Sn), Chromium (Cr), and Copper (Cu)

While the contents of the tin (Sn), the chromium (Cr), and the copper (Cu) are preferably in the ranges as suggested in the present disclosure, preferably, the tin (Sn), the chromium (Cr), and the copper (Cu) satisfy a relationship of about 1.1 wt %≦about (5×wt % of Sn+wt % of Cr+wt % of Cu)≦about 1.5 wt %.

In the relationship set forth by the formula above, if (5×wt % of Sn+wt % of Cr+wt % of Cu) is more than 1.5 wt %, coarsened carbide may be formed, which may cause a great increase in a brittleness and a friction coefficient and may cause a decrease in tensile strength and processability.

The grey cast iron having an excellent durability according to the present invention is excellent in tensile strength, fatigue strength, and friction coefficient and, thus, can be suitably applied to cylinder liners in engines of automobiles.

According to preferred embodiments of the present invention, a method for manufacturing a cylinder liner comprises putting a melted grey cast iron composition into a mold, the composition comprising carbon (C) in an amount of about 2.6 to 3.2 wt %, copper (Cu) in an amount of about 0.7 to 0.9 wt %, phosphorus (P) in an amount of about 0.4 to 0.7 wt %, molybdenum (Mo) in an amount of about 0.2 to 0.4 wt %, tin (Sn) in an amount of about 0.02 to 0.08 wt %, and a balance of iron (Fe), with trace amounts of unavoidable impurities; rotating the mold to generate a centrifugal force, thereby pressing the melted grey cast iron composition against an inner wall of the mold to form a cylindrical cast; and cooling the cylindrical cast and removing the cylindrical cast from the mold. The above wt % are based on total weight of the melted grey cast iron composition.

Herein, it is preferred that the melted composition further comprises silicon (Si) in an amount of about 1.8 to 2.2 wt %, manganese (Mn) in an amount of about 0.6 to 1.0 wt %, chromium (Cr) in an amount of less than about 0.4 wt % (and greater than 0 wt %), and sulfur (S) in an amount of less than about 0.1 wt % (and greater than 0 wt %), based on total weight of the melted grey cast iron composition. It is further preferred that the tin (Sn), the chromium (Cr), and the copper (Cu) of the melted composition satisfy a relationship of about 1.1 wt %≦about (5×wt % of Sn+wt % of Cr+wt % of Cu)≦about 1.5 wt %.

### Example

Hereinafter, the present invention will be explained in detail with reference to Examples. Examples are provided only for illustration of the present invention. It will be apparent to one of ordinary skill in the art that and the scope of the present invention cannot be construed as being limited to Examples.

Grey cast iron was formed according to the Examples (in accordance with the present invention) and Comparative Examples (in accordance with conventional compositions) in the form of cylinder liners containing the compositions and contents as listed in Table 1. The cylinder liners were prepared by a centrifugal casting method for a cylinder liner, and results of tests on hardness, tensile strength, fatigue strength, friction coefficient, and processability were compared and are listed in Table 2.

TABLE 1

| | | | | | | | | | | | 5 × Sn + |
|---|---|---|---|---|---|---|---|---|---|---|---|
| | C | Si | Mn | P | S | Cu | Cr | Sn | Mo | Fe | Cu + Cr |
| Example 1 | 2.9 | 2.0 | 0.8 | 0.5 | 0.05 | 0.80 | 0.20 | 0.04 | 0.3 | Remainder | 1.20 |
| Example 2 | 2.8 | 2.1 | 0.7 | 0.5 | 0.06 | 0.88 | 0.30 | 0.05 | 0.25 | Remainder | 1.43 |
| Comparative | 3.3 | 2.2 | 0.8 | 0.1 | 0.05 | 0.10 | 0.30 | — | — | Remainder | 0.40 |
| Example 1 | | | | | | | | | | | |
| Comparative | 2.9 | 2.0 | 0.8 | 0.5 | 0.05 | 0.80 | 0.25 | — | 0.3 | Remainder | 1.05 |
| Example 2 | | | | | | | | | | | |
| Comparative | 2.9 | 2.0 | 0.6 | 0.1 | 0.05 | 0.70 | 0.10 | 0.04 | — | Remainder | 1.00 |
| Example 3 | | | | | | | | | | | |
| Comparative | 3.4 | 2.0 | 0.8 | 0.5 | 0.05 | 0.75 | 0.20 | 0.04 | — | Remainder | 1.15 |
| Example 4 | | | | | | | | | | | |
| Comparative | 2.9 | 2.1 | 0.8 | 0.5 | 0.05 | 1.20 | 0.20 | 0.05 | 0.2 | Remainder | 1.65 |
| Example 5 | | | | | | | | | | | |

Unit: wt %

Table 1 exhibits compositions and contents of the Examples and Comparative Examples. Referring to Table 1, the Examples and Comparative Examples were prepared by using a centrifugal casting method for forming a cylinder liner. Comparative Example 1 is a composition used to form a conventional engine cylinder liner, and Comparative Examples 2 to 5 were compositions that were outside of the ranges of a composition and contents in accordance with the present invention.

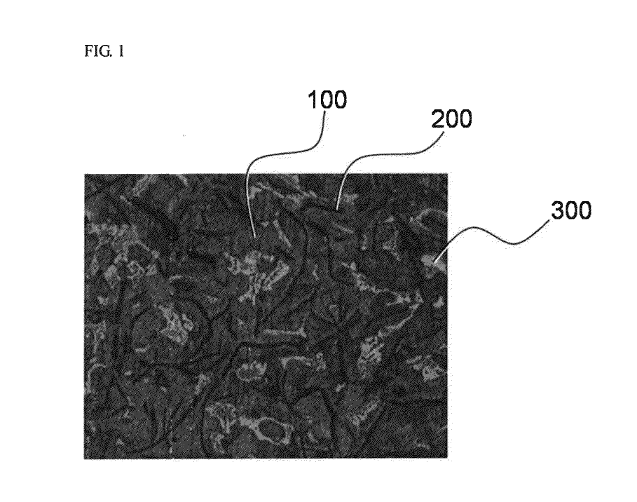

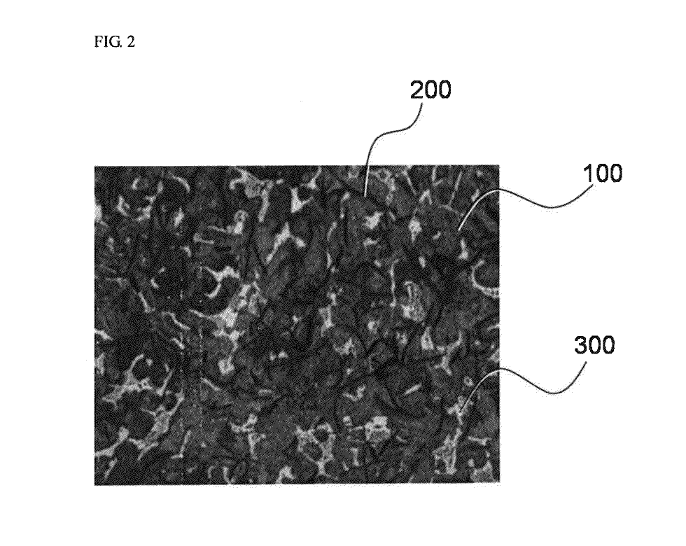

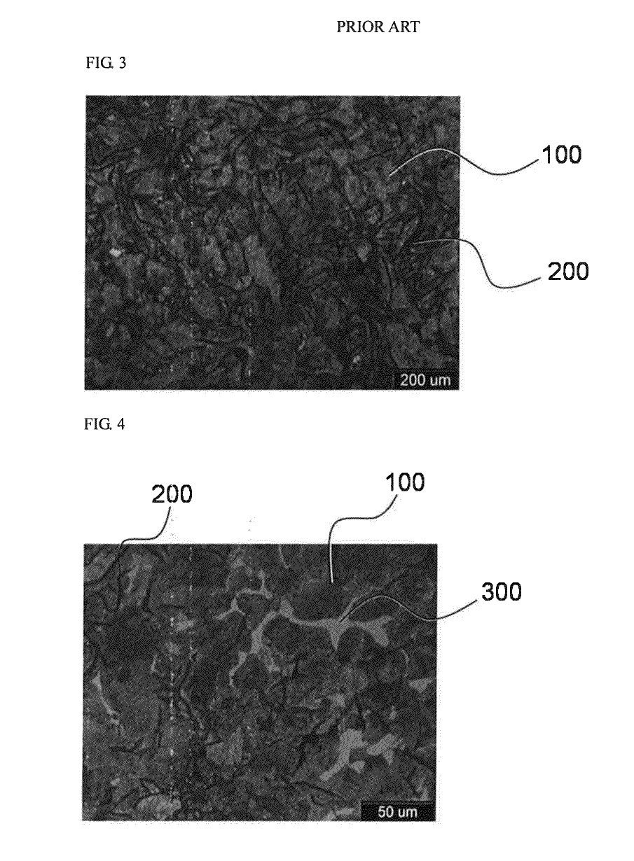

Further, FIG. 1 and FIG. 2 provide optical microscopic images taken at a 500 times magnification of micro-structures of Example 1 and Example 2. Furthermore, FIG. 3 to FIG. 7 provide optical microscopic images taken at a 500 times magnification of micro-structures of Comparative Example 1 through Comparative Example 5. As demonstrated in FIG. 1 and FIG. 2, in the micro-structures of the Examples in accordance with the present invention, pearlite 100 (which improves strength of grey cast iron), flake graphite 200 (which reduces brittleness), and carbide and phosphide as a precipitate phase 300 (which help to improve strength of the grey cast iron) were evenly distributed. On the other hand, as demonstrated in FIG. 3 through FIG. 7, in the Comparative Examples which were not in accordance with the present invention, the pearlite 100, the flake graphite 200, and the precipitate phase 300 were unevenly or inadequately distributed.

TABLE 2

| | | Tensile | Fatigue | | |
|---|---|---|---|---|---|
| | Hardness | strength | strength | Friction | |
| | (HRB) | (MPa) | (MPa) | coefficient | Processability |
| Example 1 | 103 | 335 | 152 | 0.041 | 95 |
| Example 2 | 105 | 343 | 158 | 0.042 | 93 |
| Comparative | 95 | 260 | 98 | 0.051 | 100 |
| Example 1 | | | | | |
| Comparative | 99 | 320 | 135 | 0.050 | 95 |
| Example 2 | | | | | |
| Comparative | 103 | 315 | 123 | 0.048 | 93 |
| Example 3 | | | | | |
| Comparative | 96 | 270 | 115 | 0.050 | 98 |
| Example 4 | | | | | |
| Comparative | 105 | 340 | 155 | 0.057 | 75 |
| Example 5 | | | | | |

Table 2 exhibits comparison results of hardness, tensile strength, fatigue strength, friction coefficient, and processability measured from the Examples and Comparative Examples prepared with reference to the composition and the contents as listed in Table 1. In particular, the hardness was measured by using a Brinell hardness tester after the Examples and Comparative Examples were evenly processed, the tensile strength was measured as specified by KS D0801 8A, and the fatigue strength was measured by applying a rotary bending stress one million cycles or more after the Examples and Comparative Examples formed in a U-shaped notch were prepared.

Further, the friction coefficient was measured when a friction coefficient became stabilized through a reciprocating abrasion process onto a steel material for piston ring while the Examples and Comparative Examples were loaded with a weight of 100 N under an engine oil lubrication environment. The processability was exhibited as a ratio of lifespan of tools used for preparing the Examples and Comparative Examples with reference to Comparative Example 1 which was set at 100. In the Examples, processability relates to lifespan, and Comparative Example 1 is set as the reference because it is a conventionally known material.

As shown FIG. 1 and FIG. 2, in Example 1 and Example 2 (which were in accordance with the present invention), the pearlite 100, the flake graphite 200, and the precipitate phase 300 were evenly distributed as compared with Comparative Example 1 (which was a material for a conventional engine cylinder liner). Therefore, it was demonstrated that mechanical properties were greatly improved, such as hardness which increased by about 10%, tensile strength which increased by about 35%, and fatigue strength which increased by about 50% (a decrease in the values of the Examples relative to Comparative Example 1). Further, the friction coefficient decreased by about 20%, thereby improving a friction-reducing effect (a decrease in the values of the Examples relative to Comparative Example 1).

The above results mean that if Example 1 and Example 2 according to the present invention are applied to a cylinder liner or the like, a lifespan of the cylinder liner or the like, which is provided with excellent properties and frictional properties, can also be greatly increased.

As can be seen from FIG. 3, since Comparative Example 1 included excessive carbon (C), insufficient phosphorus (P) and copper (Cu) but did not include tin (Sn) and molybdenum (Mo), a precipitate phase was rarely formed, and, thus, properties were deteriorated overall as compared with the Examples 1 and 2.

As can be seen from FIG. 4, Comparative Example 2 did not include tin (Sn) and was outside of the range of the relationship of about 1.1 wt %≦about (5×wt % of Sn+wt % of Cr+wt % of Cu)≦about 1.5 wt %. As such, formation of a precipitate phase, particularly carbide, was suppressed, and, thus, hardness, tensile strength, and fatigue strength were reduced and a friction coefficient was increased as compared to the values of Examples 1 and 2.

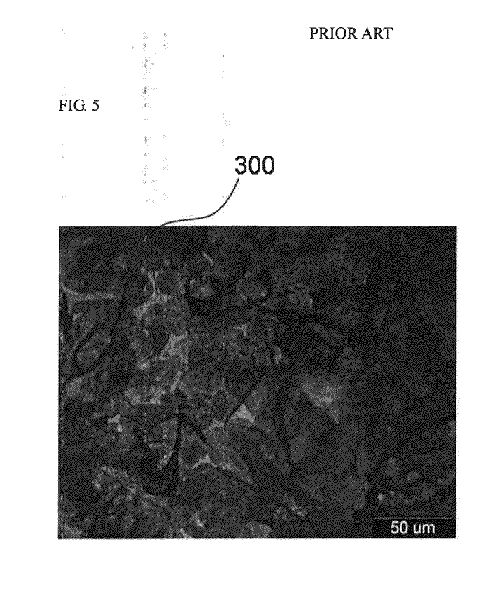

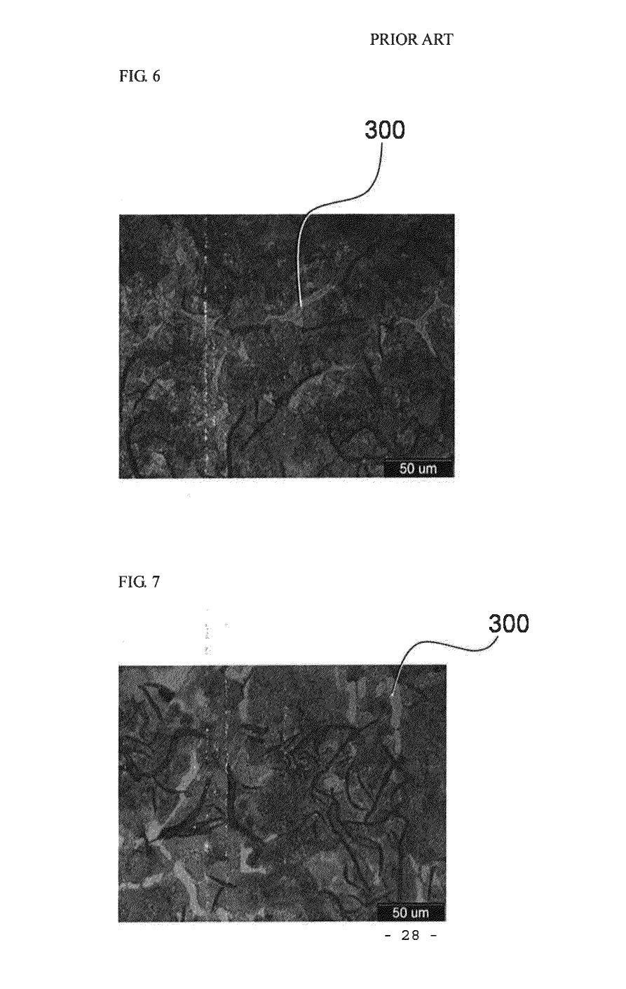

Further, as can be seen from FIG. 5 and FIG. 6, since Comparative Example 3 and Comparative Example 4 did not include molybdenum (Mo), pearlite was not refined and formation of flake graphite was suppressed. As a result, while tensile strength was equivalent to the Examples, fatigue strength was greatly reduced.

Furthermore, as can be seen from FIG. 7, in Comparative Example 5 when the total content of chromium (Cr), copper (Cu), and tin (Sn) was higher than that of the present invention, the relationship of about 1.1 wt %≦about (5×wt % of Sn+wt % of Cr+wt % of Cu)≦about 1.5 wt % was not satisfied, and, thus, coarsened carbide was formed, which may cause a great decrease in processability and an increase in friction coefficient.

Therefore, Examples according to the present invention have superior mechanical properties, frictional properties, and processability as compared with Comparative Examples and, thus, can be suitably applied to cylinder liners.

Although the present invention has been described only in conjunction with the described specific embodiments in detail, such embodiments are provided only for illustration and the present invention is not limited thereto. It will be apparent to one of ordinary skill in the art that various modifications and variations of the described embodiments can be made without departing from the scope of the present invention within the spirit and scope of the invention as defined by the appended claims and their equivalents.

What is claimed is:

1. A grey cast iron comprising:
carbon (C) in an amount of about 2.6 to 3.2 wt %;
copper (Cu) in an amount of about 0.7 to 0.9 wt %;
phosphorus (P) in an amount of about 0.4 to 0.7 wt %,
molybdenum (Mo) in an amount of about 0.2 to 0.4 wt %,
tin (Sn) in an amount of about 0.02 to 0.08 wt %;
a balance of iron (Fe); and
trace amounts of impurities,
wherein the wt % are relative to the total weight of the grey cast iron.

2. The grey cast iron of claim 1, wherein the grey cast iron further comprises:
silicon (Si) in an amount of about 1.8 to 2.2 wt %; manganese (Mn) in an amount of about 0.6 to 1.0 wt %; chromium (Cr) in an amount of less than about 0.4 wt % and greater than 0 wt %; and
sulfur (S) in an amount of less than about 0.1 wt % and greater than 0 wt %,
wherein the wt % are relative to the total weight of the grey cast iron.

3. The grey cast iron of claim 2, wherein the tin (Sn), the chromium (Cr), and the copper (Cu) satisfy a relationship of about 1.1 wt %≦about (5×wt % of Sn+wt % of Cr+wt % of Cu)≦about 1.5 wt %.

4. The grey cast iron of claim 2, wherein the grey cast iron has a tensile strength of about 270 to 400 MPa, a fatigue strength of about 120 to 190 MPa, and a friction coefficient of about 0.03 to 0.05.

5. A method for manufacturing a cylinder liner, the method comprising:
putting a melted grey cast iron composition into a mold, the melted grey case iron composition comprising carbon (C) in an amount of about 2.6 to 3.2 wt %, copper (Cu) in an amount of about 0.7 to 0.9 wt %, phosphorus (P) in an amount of about 0.4 to 0.7 wt %, molybdenum (Mo) in an amount of about 0.2 to 0.4 wt %, tin (Sn) in an amount of about 0.02 to 0.08 wt %, and a balance of iron (Fe) and trace amounts of impurities, based on total weight of the melted grey cast iron composition;
rotating the mold to general a centrifugal force, thereby pressing the melted grey cast iron composition against an inner wall of the mold to form a cylindrical cast; and
cooling the cylindrical cast and removing the cylindrical cast from the mold.

6. The method for manufacturing a cylinder liner of claim 5, wherein the melted grey cast iron composition further comprises silicon (Si) in an amount of about 1.8 to 2.2 wt %, manganese (Mn) in an amount of about 0.6 to 1.0 wt %, chromium (Cr) in an amount of less than about 0.4 wt % and greater than 0 wt %, and sulfur (S) in an amount of less than about 0.1 wt % and greater than 0 wt %, based on total weight of the melted grey cast iron composition.

7. The method for manufacturing a cylinder liner of claim 6, wherein the tin (Sn), the chromium (Cr), and the copper (Cu) of the melted grey cast iron composition satisfy a relationship of about 1.1 wt %≦about (5×wt % of Sn+wt % of Cr+wt % of Cu)≦about 1.5 wt %.

8. A cylinder liner formed by the method of claim 5.
